(19) United States
(12) Patent Application Publication
(10) Pub. No.: US 2024/0306841 A1
(43) Pub. Date: Sep. 19, 2024

(54) FRENCH PRESS COFFEE MAKER APPARATUS AND METHOD WITH EASE OF CLEANING FEATURES

(71) Applicant: Scott Kimmel, St. Paul, MN (US)

(72) Inventor: Scott Kimmel, St. Paul, MN (US)

(21) Appl. No.: 18/123,941

(22) Filed: Mar. 20, 2023

Related U.S. Application Data
(60) Provisional application No. 63/331,814, filed on Apr. 16, 2022.
(60) Provisional application No. 63/322,000, filed on Mar. 21, 2022.

(51) Int. Cl. A47J 31/20; A47J 31/44; A47J 31/60

(52) U.S. Cl. CPC A47J 31/20; A47J 31/4403; A47J 31/60

(57) ABSTRACT

A French press apparatus comprising a carafe having an open top and an open bottom, the top and the bottom being coaxial. A top disc has a peripheral edge that engages the cross-section of the carafe and is perforate and allows liquid passage through at least a part of the surface thereof. An elongated driving rod is selectively engaged with the top disc whereby an axial force on the elongated driving rod will plunge the top disc through any liquid disposed above the bottom disc. The driving rod facilitates removal of the bottom disc and cleaning of the apparatus. Some embodiments connect the carafe to the bottom disc with cooperating first and second luers.

### TECHNICAL FIELD

The present invention is generally directed to coffee brewing apparatus. More particularly, the present invention is directed to such apparatus known as a French press coffee brewing apparatus that makes it easier to clean the used coffee grounds out of the French press.

A French press makes coffee by (a) immersing ground coffee in hot water in a carafe and (2) then separating the grounds from the coffee by pressing a piston or plunger with an integral filter through the steeping liquid to push the coffee grounds to the bottom of the carafe. Accordingly, coffee without the grounds can then be poured out of the carafe.

The modern French press coffee maker consists of a narrow cylindrical beaker or carafe, usually made of glass or clear plastic, which cooperates with a metal or plastic lid to facilitate pouring from the carafe and a piston or plunger that fits tightly into the cylinder and has a fine stainless steel wire or nylon mesh filter.

Coffee is brewed or steeped by placing coarsely ground coffee in the empty beaker or carafe and adding hot water. A French press works best with coffee of a coarser grind than does a drip brew coffee filter. Finer coffee grounds, when immersed in water, have lower permeability, requiring an excessive amount of force to be applied by hand to lower the plunger and are more likely to seep through or around the perimeter of the press filter and into the coffee drink. Additionally, finer grounds will tend to over-extract and cause the coffee to taste bitter.

### BACKGROUND OF THE INVENTION

Cleaning the used coffee grounds out of a French press after brewing coffee can be a tedious, difficult, and dirty process. One can pour water into the press to create a slurry mixture and then pour the slurry into the trash or into the sink. If one does not have an adequate garbage disposal, over time the coffee grounds in the slurry can build up and clog the sink. This can lead to an expensive remediation by a plumber. Otherwise, the slurry in the trash can begins to smell and requires the garbage can to be cleaned out.

Sometimes, the slurry breaks through the garbage can bag and then the garbage can has to be cleaned out. Another method for cleaning out the grounds is to use a giant spoon and scoop them out. This takes time, and it is difficult to completely remove the grounds. From the above, it is therefore seen that there exists a need in the art to overcome the deficiencies and limitations described herein and above.

Systems have been designed for cleaning the spent grounds out of the carafe. In one system, there is a plate on the bottom of the carafe and during the cleaning process, a hook is attached to the plate. The plate is then pulled up, along with the coffee grounds. In another system, a basket is placed at the bottom of the carafe. In the cleaning process, the basket is pulled up. Still another system has an integrated ladle, in which the bottom of the ladle is flush with the bottom of the carafe. The carafe has a notch in its wall that receives the ladle arm, which extends vertically and has an area for grasping at its top. During the cleaning process, the top of the ladle is pulled upward to remove the spent coffee grounds.

### SUMMARY OF THE INVENTION

The shortcomings of the prior art are overcome and additional advantages are provided in a French press apparatus comprising a carafe having an open top and an open bottom, the top and the bottom being coaxial, the carafe being axially elongated and having the same internal cross-section at a plurality of axially spaced intervals; a top disc having a peripheral edge that is dimensioned and configured for sealing engagement with respective internal cross-sections of the carafe, the top disc being perforate and allowing liquid passage through at least a part of the surface thereof; a bottom disc having a peripheral edge that is dimensioned and configured for sealing engagement with respective internal cross sections of the carafe, the bottom disc being imperforate and all of or a portion forming a reversible, waterproof mate with the carafe. An elongated driving rod disposed in a perpendicular relationship to the top disc, an axial part of the elongated driving rod being selectively engaged with the top disc whereby an axial force on the elongated driving rod will plunge the top disc through any liquid disposed above the bottom disc, and an axial part of the elongated driving rod also being disposed in perpendicular relationship to the bottom disc and selectively engaged with the bottom disc to facilitate removal of the bottom disc and cleaning of the apparatus.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. Although specific features of various exemplary embodiments of the invention may be shown in some drawings and not in others, this is for convenience only. In accordance with the principles of the invention, any feature of a drawing may be referenced and/or claimed in combination with any feature of any other drawing.

According to common practice, the various features of the drawings discussed below are not necessarily drawn to scale. Dimensions of various features and elements in the drawings may be expanded or reduced to illustrate more clearly the embodiments of the disclosure.

The invention, however, both as to organization and method of practice, together with the further objects and advantages thereof, may best be understood by reference to the following description taken in connection with the accompanying drawings in which:

FIG. 1 is an exploded view of an embodiment of the French press in accordance with the present invention.

FIGS. 2A-2G illustrates the operational sequence of the French press illustrated in FIG. 1.

FIGS. 3A-3B illustrates an embodiment of the present invention having a base having a central aperture in which a passive valve is positioned at the bottom axial extremity of the carafe.

FIGS. 4A-4C illustrates the integration of a medical luer fitting interface between the bottom disc and the passive valve disposed in the central aperture of the base.

FIGS. 5A-5B illustrate an embodiment in which instead of the driving rod being detachable from the top disc, the driving rod is inserted into the upper axial extent of a tube 17 that is permanently or reversible connected to the top disc to permit the driving rod to extend through the passive valve and the luer fitting and connect to the bottom disc.

FIG. 5C illustrates the driving rod in greater detail.

FIG. 6A illustrates another embodiment of the bottom disc assembly having upper, middle and bottom components.

FIG. 6B illustrates the assembled bottom disc.

FIG. 6C illustrates a sectional view of a conventional carafe with a bottom disc assembly and the driving rod in accordance with the present invention.

FIG. 7 illustrates an embodiment including a wiper integrated into the bottom disc and reversibly attached to the driving rod. For simplicity, the drawing omits, for example, carafe 1 shown in FIG. 1.

FIGS. 8A-8B illustrates another embodiment for a French Press coffee maker embodiment that includes a magnetic bottom disc and a pulling rod having a magnetic lower axial extremity.

FIGS. 9A-9B illustrates an embodiment including a plug to selectively seal the bottom carafe opening.

FIG. 10A illustrates an embodiment illustrating a plug on the bottom surface of the bottom disc having an outer truncated conical flexible polymer or rubber surface dimensioned and configured to engage and seal the bottom carafe opening.

FIG. 10B illustrates an embodiment illustrating the integration of a plug on the bottom surface of the bottom disc having an outer truncated conical surface dimensioned and configured to engage and seal the bottom carafe opening with a friction fit.

FIG. 11 illustrates an embodiment having cooperating helical threads securing the bottom disc to the bottom carafe opening.

FIG. 12 illustrates an embodiment having a bayonet connection between the bottom disc and the bottom carafe opening.

FIG. 13A illustrates the manual placement of a bottom disc over a bottom opening of the carafe.

FIGS. 13B illustrate an embodiment that includes placement of a bottom disc over a bottom opening of the carafe using the driving rod.

FIGS. 14A and 14B illustrate respectively assembled and exploded views of a cylinder that cooperates with the bottom disc to hold the ground coffee during coffee brewing. The cylinder is subsequently detached from the bottom disc to facilitate disposal of the spent grounds.

FIG. 15 illustrates an embodiment in which a driving rod is selectively attached to a carafe frame.

FIGS. 16A and 16B illustrate an embodiment in which the bottom disc is pushed by hand rather than with a rod.

FIGS. 17A and 17B illustrate an embodiment in which the bottom disc is spring biased upwardly. For simplicity, the drawing omits, for example, the bottom lid 34 shown in FIG. 3A.

FIG. 18 illustrates an embodiment in which a syringe is utilized to clean the used coffee grounds out of the carafe.

FIGS. 19A-19C illustrates an embodiment that does not include a bottom disc.

FIGS. 20A-20B illustrates an embodiment that integrates tab features for improving the separation of the used coffee grounds from the bottom disc.

### DETAILED DESCRIPTION

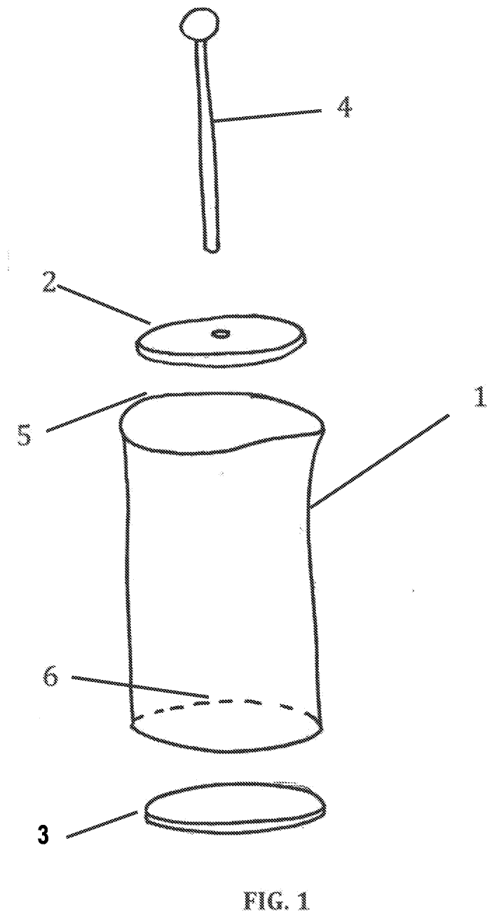

In a first embodiment, a French press coffee maker assembly illustrated in FIG. 1, includes a carafe 1, a top disc 2, a bottom disc 3, and a driving rod 4. The carafe 1 has a cylindrical shape and a top opening 5 and a bottom opening 6. A driving rod 4 is reversibly attached to both the top disc 2 and the bottom disc 3. The top disc 2 as well as the bottom disc 3 can moved independently along the geometric axis of the carafe 1. The combination of the driving rod 4 and the top disc 2 may also be referred to as plunger assembly. The circumferential or peripheral parts of the top disc 2 and bottom disc 3 are dimensioned and configured for sealing engagement with the inner surface of the carafe 1. The top disc 2 in all embodiments disclosed herein has a standard filter design found in French presses. The construction of a conventional filter apparatus is shown in US published patent application 2003/0047081 by Gary McGongagle and published Mar. 13, 2003.

More particularly, the top disc 2 (a) allows for fluid movement through the disc 2 and (b) does not allow movement of coffee grounds through or around the top disc 2. The bottom disc 3 is imperforate and is dimensioned and configured for sealing engagement with the inner surface of the carafe 1. Some embodiments may have a peripheral O-ring seal (not shown) to substantially prevent fluid or coffee grounds through or around the bottom disc 3. The materials used to construct all embodiments are preferably of food grade.

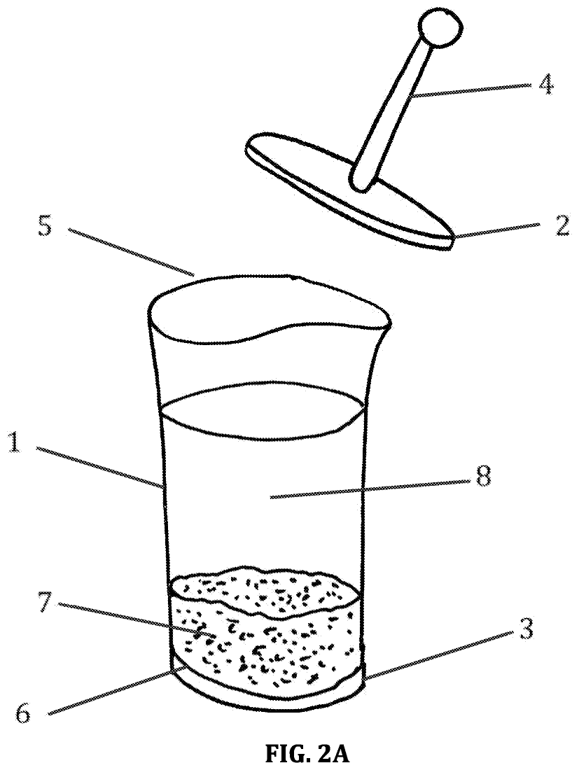

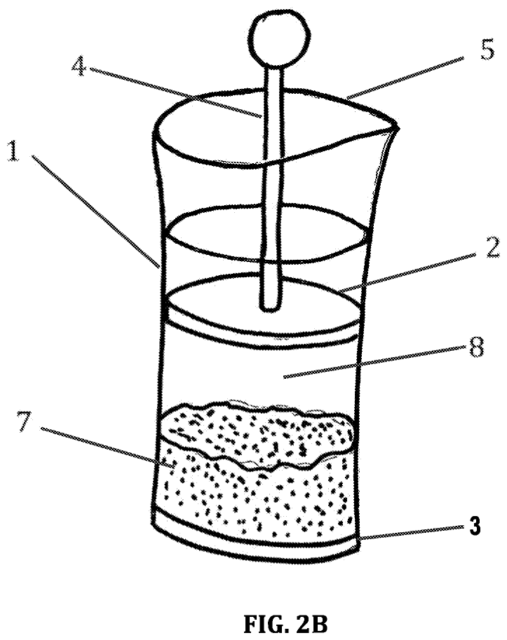

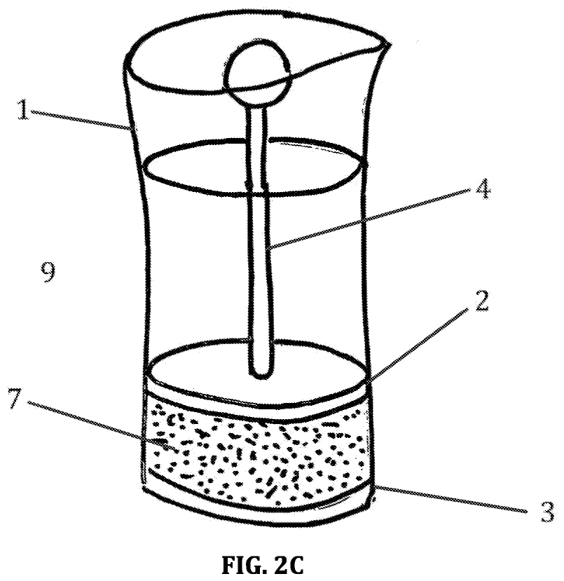

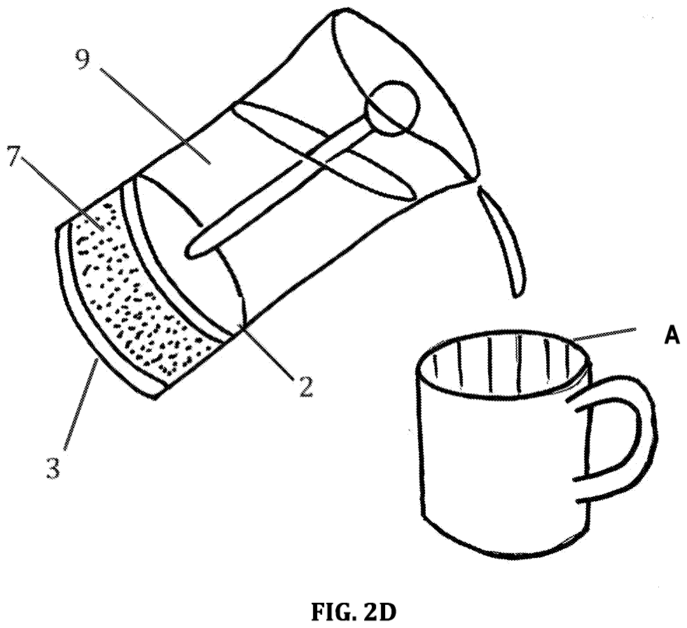

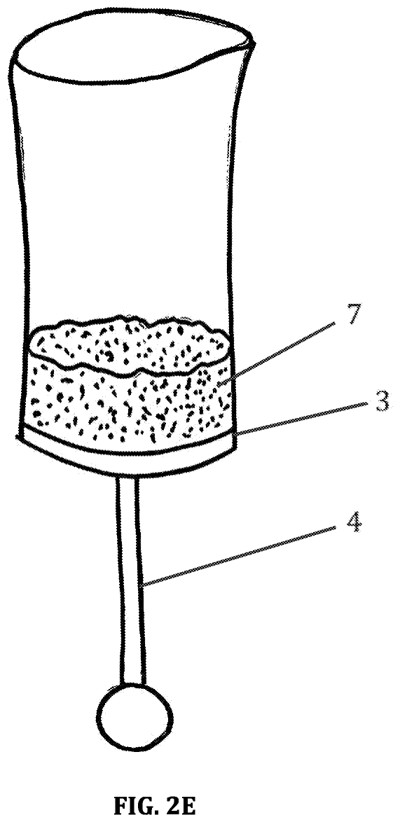

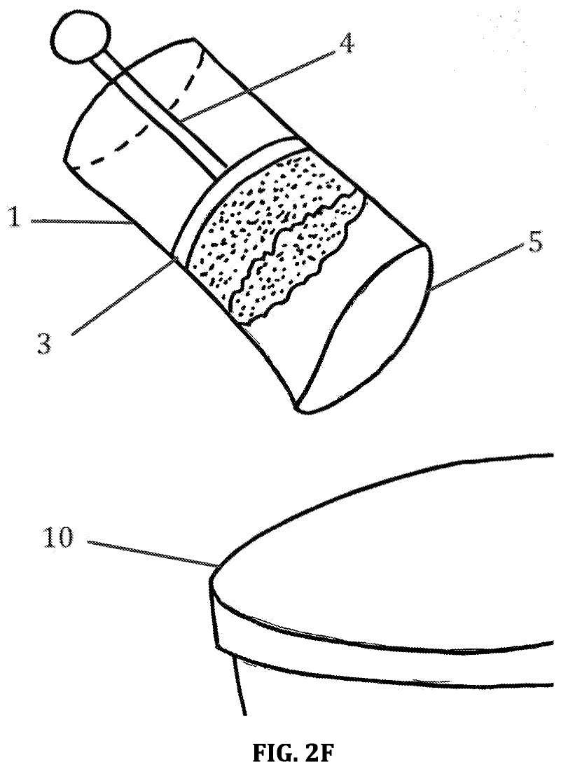

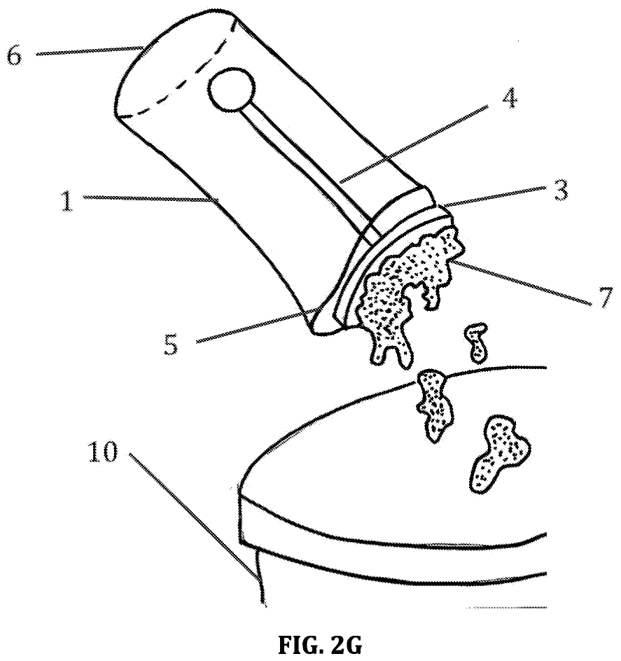

As illustrated in FIG. 2A, in use, the bottom disc 3 is first disposed at the bottom of the carafe 1 so that the bottom opening 6 of the carafe 1 is completely closed. Ground coffee beans 7 are placed on the top surface of the bottom disc 3 and hot water 8 is poured into the top opening 5 of the carafe 1. The bottom disc 3 forms a liquid tight seal with the carafe 1 so that the hot water 8 does not escape through the bottom opening 6 of the carafe 1. This liquid tight seal is achieved with an O-Ring (not shown) disposed on the circumference of the bottom disc 3. The O-Ring is made of silicone or equivalent rubber material. Those of skill in the art will appreciate that other methods could be used to seal the surface between the bottom disc 3 and the carafe 1. While the hot water 8 and ground coffee beans 7 are steeping, the driving rod 4 is attached to the top disc 2. Collectively, the driving rod attached to the top disc is sometimes referred to as a plunger. This attachment is achieved in various embodiments via mating screw threads, a snap fit, a compression fit, a detent mechanism, or the like.

As illustrated in FIG. 2B, after the hot water 8 and ground coffee beans 7 have steeped for the required time-period, the top disc 2 and driving rod 4 assembly is placed at the top opening 5 of the carafe 1 and then the driving rod commences to be moved downward towards the ground coffee beans 7 and the bottom disc 3.

As illustrated in FIG. 2C, the top disc 2 and driving rod 4 assembly has been completely pressed down or plunged so that the top disc 2 has moved axially along the axis of the carafe 1 down towards the bottom disc 3. The top disc 2 includes a filter feature, which allows the coffee-infused hot water from the ground coffee beans 7 to pass through the top disc 2. Thus, when the top disc 2 has touched the top of the ground coffee beans 7, a column of brewed coffee 9 is disposed above the top disc 2 within the carafe 1.

As illustrated in FIG. 2D, the coffee 9 can then be poured out into, for example, a cup A, leaving the spent coffee grounds 7 between the top disc 2 and bottom disc 3.

After the coffee 9 has been poured out, the cleaning process can start. First, the driving rod 4 and top disc 2 assembly are removed from the carafe 1. Next the driving rod 4 is detached from the top disc 2. As illustrated in FIG. 2E, the driving rod 4 is then attached to the bottom surface of the bottom disc 3. In the same manner that the driving rod is attached to the top of disc 2, the driving rod 4 can also be attached to the bottom of disc 3. More particularly, each such attachment can be achieved via mating screw threads, a snap fit, a compression fit, a detent mechanism, or the like.

Next, as illustrated in FIG. 2F, the carafe 1 and driving rod 4 and bottom disc assembly 3 is positioned over a trash can 10 with the carafe 1 top opening 5 downward.

Finally, as illustrated in FIG. 2G, the driving rod 4 and bottom disc 3 assembly is pressed towards the top opening 5 of the carafe 1. As the bottom disc 3 approaches the top opening 5 of the carafe 1, the spent coffee grounds 7, which are sitting on the top surface of the bottom disc 3, are forced out of the top opening 5 of the carafe 1 and into the trash can 10. Because of the tight seal that the bottom disc 3 forms with the inner surface of the carafe 1, none of the spent coffee grounds 7 can escape past the bottom disc 3 and remain in the carafe 1 or escape out of the bottom opening 6 during the cleaning process. Those skilled in the art will appreciate that the seal between the bottom disc 3 and the carafe 1 may not need not to be watertight during every step. For example, the seal could be watertight while the bottom disc 3 is disposed at the bottom of the carafe 1 during the coffee making step. However, when the bottom disc 3 is sliding up and down in the axial direction within the carafe 1, such as during the cleaning step, the seal between the bottom disc 3 and carafe 1 could be tight enough to prevent used coffee grounds from escaping past the bottom disc, but not tight enough that it is difficult to slide the bottom disc 3 up and down. The construction of the seals will be understood to to be similar to that described in U.S. Pat. No. 5,618,570 issued Apr. 8, 1997, to Stephen H. Banks et al.

Those skilled in the art will appreciate that the above description contains the basic elements of the French press and alternate components may provide advantages including facilitating ease of use.

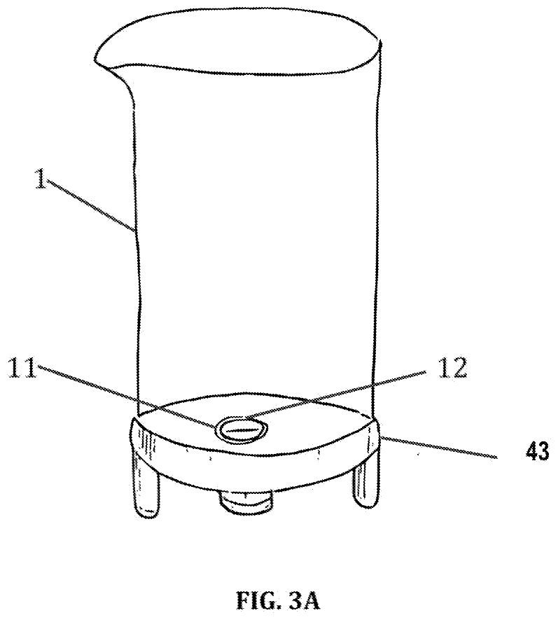

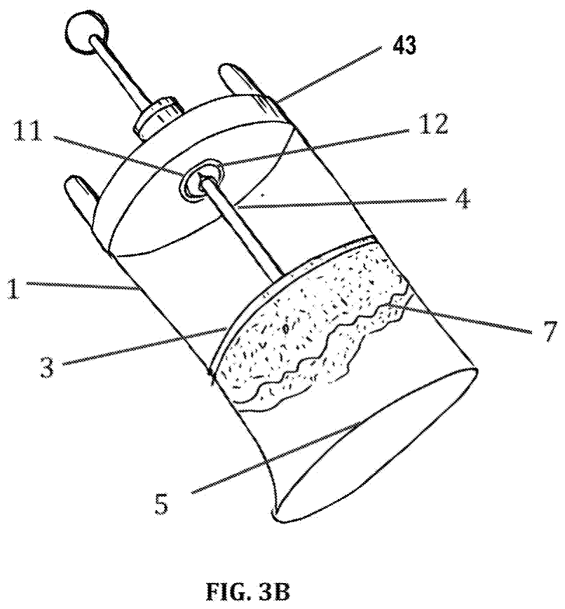

Embodiments of the present invention may include a refinement illustrated in FIG. 3A. In this embodiment, the diameter of the bottom opening of the carafe 6 as shown for example in FIG. 2A is reduced in size to form a smaller bottom opening 11 in the bottom of the carafe 1. The diameter of the smaller bottom opening 11 of the carafe 1 is smaller than the diameter of the top opening 5 of the carafe 1 and also slightly bigger than the diameter of the driving rod 4 . . . A valve 12 is located in the bottom opening 11 in some embodiments. The valve 12 may be either active or passive. An example of a passive valve that is responsive to rotation of a sleeve is the Boston Scientific® Rapido® Cut-Away® Guiding Catheter System. A stand 43 is selectively positioned on the bottom of the carafe 1 so that when the carafe 1 is placed on a table or the like there is clearance for the a portion of the valve 12 which may protrude from the bottom surface of the carafe 1. Those skilled in the art will appreciate that the stand 43 could be incorporated into any of the embodiments described in order to provide clearance for features on the bottom of the carafe 1 as necessary.

An example of a suitable passive valve is shown in U.S. Pat. No. 4,857,062 entitled Catheter Introducer Valve issued to Michael A. Russell. Passive valves are not opened or closed by the user, they automatically seal around a device inserted through the valve. This catheter insertion valve comprises a central tubular body and a non-removable tubular cap that can be screwed onto the body wherein a bore extends through the body and the cap defines a pathway for a catheter. The passive valve in medical applications facilitates, for example, insertion of a catheter into arteries, organs, or body cavities for the purpose of introducing medications of instruments for treatment, diagnosis or the performing of in vivo procedures. A seal located within the central body of the valve is used to form a fluid-tight seal about the catheter, guidewire or other instrument extending therethrough. Alternatively, the seal can completely close off the pathway when it is not being used for catheter insertion thereby preventing air entrainment. The central body is provided with one or more seal position indicators to indicate to the operator that a seal has been formed about a catheter or guidewire of standard dimension. The seal is manually adjusted by rotating a non-removable cap.

An active valve would be one that functions in a similar fashion to a Tuohy-Borst valve, which is commonly used in medical devices such as catheters. As described in U.S. Pat. No. 5,195,980 issued Mar. 23, 1993, to David G. Catlin, such valves are in a class of hemostatic valves having gaskets sealing around a needle, catheter or the like. When a needle, catheter or the like is removed, the valve closes. When access to the vascular system is required, control of bleeding is essential. Thus various connectors or other devices used for intravascular applications make use of a hemostatic valve to enable a catheter or other small diameter instrument to be introduced into the body of a living being while precluding blood from flowing out of the connector. For example, in angioplasty it is a common practice to introduce an angioplasty catheter, e.g., a balloon catheter, through a hemostatic valve located within a connector. The hemostatic valve and its associated connector is used with a conventional guiding catheter to guide a tubular portion of the connector into the interior of the patient's artery The hemostatic valve ensures that blood does not flow out of the connector, while enabling the insertion of the angioplasty catheter.

As illustrated in FIG. 3B, when cleaning the carafe 1, the valve 12 is opened, either actively or passively, and allows the passage of the driving rod 4 through the bottom opening 11 of the carafe 1 so that the driving rod 4 engages the bottom disc 3 and to press the bottom disc 3 and coffee grounds 7 out of the top 5 of the carafe 1. In FIG. 3B the upper disc 2 has been removed before the cleaning step. Thus, this embodiment includes both top disc 2 and bottom disc 3 as shown, for example, in FIG. 2C.

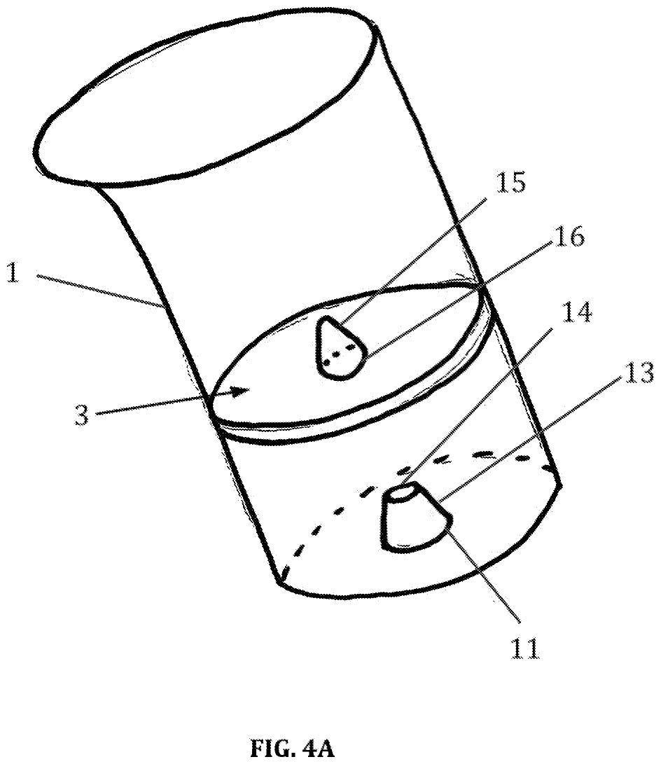

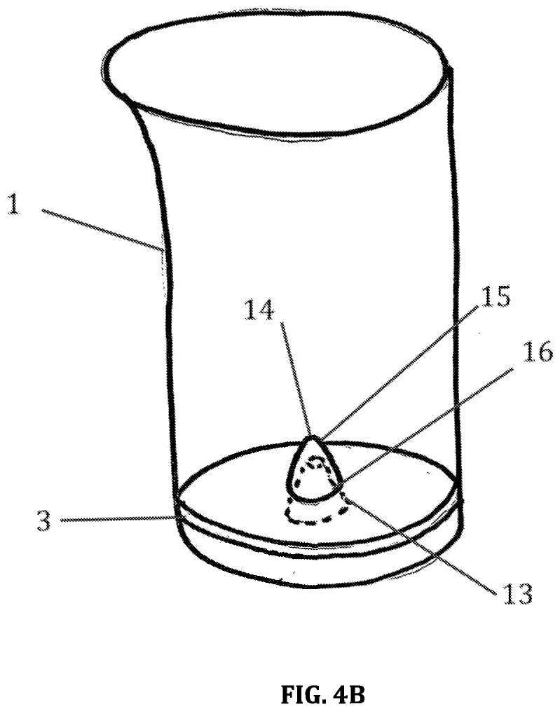

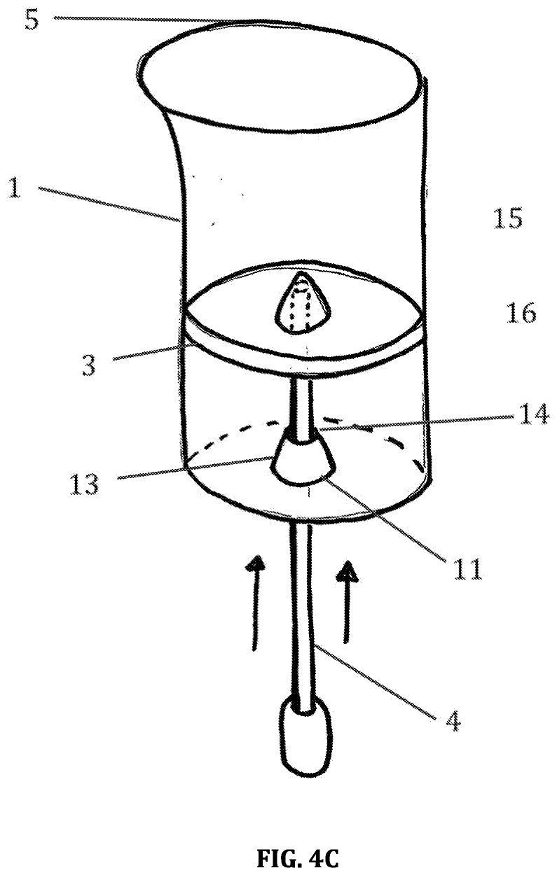

As illustrated in FIG. 4A, medical luer geometry is integrated into the fitting between the bottom disc 3 and the smaller bottom opening 11 of the carafe 1 to form an easily reversible water tight seal between the bottom disc 3 and the carafe 1.

A medical luer connection as described, for example, in US published patent application 2009/0143770 dated Jun. 4, 2009, by Mark Ries Robinson improves liquid mixing thereby reducing areas of low or stagnant flow within a plenum chamber formed between the male and female luer connectors. Stagnation or low flow areas in the plenum can be reduced by imparting a non-axial flow component to the fluid flow as it passes through the plenum. Improvement of the cleaning effectiveness of the luer connection reduces the amount of flushing fluid needed to clean the connection, and reduces the residual matter at a fixed volume of fluid relative to a standard luer connection.

An advantage of this embodiment is that it eliminates the need for a valve. In this embodiment, the bottom of the carafe 1 includes a taper 13 that matches a male luer taper like that at the tip of a syringe. As described by Wikipedia the luer taper is a standardized system of small-scale fluid fittings used for making leak-free connections between a male-taper fitting and its mating female part on medical and laboratory instruments, including hypodermic syringe tips and needles or stopcocks and needles. An example of a luer connection is shown in U.S. Pat. No. 6,893,056 issued on May 17,2007, to Gianni Guala.

The taper 13 juts into the inner volume of the carafe 1. At the top of the taper 13, is an opening 14 that is smaller than the opening 11 at the bottom of the taper. The bottom disc 3 has a corresponding mating female luer geometry which consists of a taper 15 and an opening 16 that engages the male taper 13. The top of the female taper 15 is closed and does not have an opening.

As illustrated in FIG. 4B, when the bottom disc 3 is located at the bottom of the carafe 1, the male taper 13 has been inserted into the opening 16 of the female taper 15. In this configuration, the female taper 15 is completely seated on the male taper 13 and the opening 14 at the top of the male taper 13 is closed off and this forms a watertight seal between the bottom disc 3 and the carafe 1.

As illustrated in FIG. 4C, embodiments of the present invention incorporating cooperating medical leurs or tapers on the disc 3 and the bottom of the carafe 1 allow insertion of the driving rod 4 into the opening 11 at the bottom of the male taper 13 when cleaning the carafe 1. Continued travel of the driving rod 4 passes through the opening 14 at the top of the male taper 13 and into the opening 16 at the bottom of the female taper 15 results in the tip of the driving rod bottoming out at the top of the female taper 15. Further axial advance of the driving rod 4 separates the bottom disc 3 from the bottom and the carafe 1. In a similar fashion as shown in FIG. 2G and FIG. 3B, the driving rod 4 and bottom disc 3 would be advanced such that the bottom disc 3 exits the top opening 5 of the carafe 1 for coffee ground 7 disposal.

Those skill in the art will appreciate that the two luer geometries could be switched such that the female luer geometry would be located at the bottom of the carafe 1 while the male luer geometry could be located on the bottom disc 3. In addition, combinations of more than one of each luer geometry could be incorporated into either or both of the carafe 1 and the bottom disc 3. Furthermore, the female or male luer geometry could be incorporated into only the carafe 1 or only the bottom disc 3 and an extra luer cap or plug could be used to seal the opening on the carafe 1 or the bottom disc 3. Other embodiments achieve a watertight seal between the bottom disc 3 and bottom opening 11 of the the carafe 1 with an insert plug, a slidable lid, a threaded plug, a disposable plug, etc. Those of skill in the art will appreciate that geometry that is a variation of the medical luer geometry could be utilized. For example, the female and male luers may have taper angles that differ from those used in medical devices. Also, the geometry could be scaled up or down in size.

In another embodiment, the bottom disc 3 is reusable and is composed of a low friction material such that the used coffee grounds would easily separate from the bottom disc 3 and fall into the trash. Examples of low friction materials include plastics selected from a group that includes but is not limited to acetal, nylon, PET, PEEK, UHMW, HDPE, and PTFE polymers. Another suitable material is a PTFE coated metal such as stainless steel, aluminum, titanium, and the like.

In another embodiment, the bottom disc 3 is disposable and thrown away with the used coffee grounds after every cleaning step. In this case, the bottom disc 3 could be composed of a compostable material or the like.

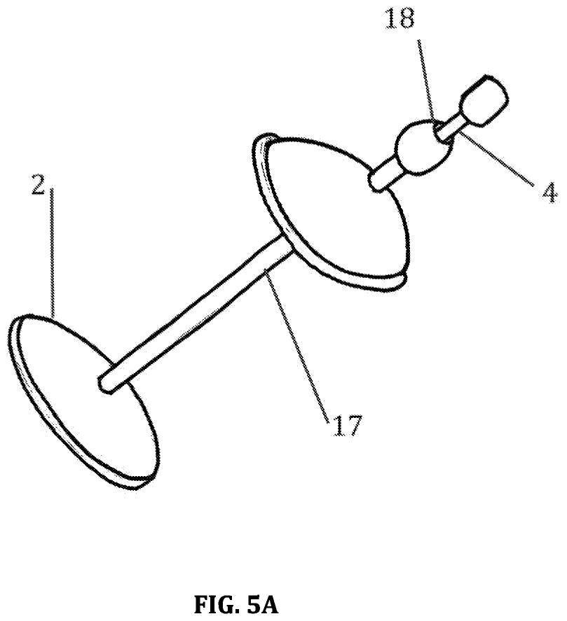

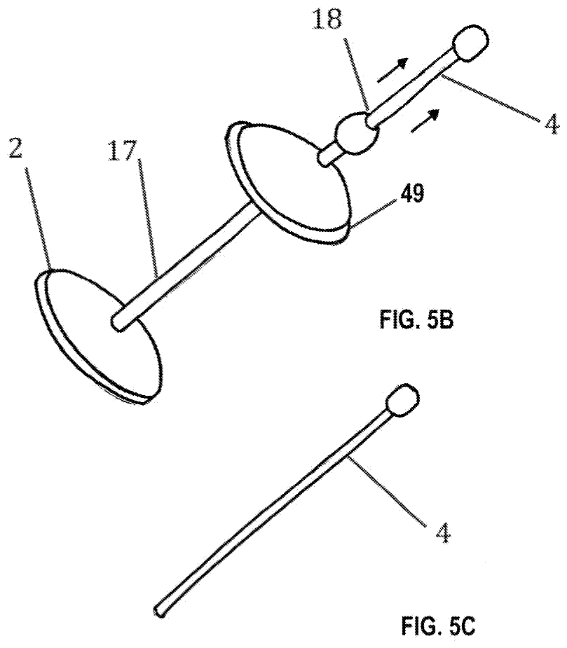

In the embodiment illustrated in FIG. 5A, the driving rod 4 is not directly selectively detachable from the top disc 2. Instead the driving rod 4 extends coaxially within a tube 17. More particularly, the driving rod 4 extends into the upper axial extremity 18 of a tube 17 that is permanently or selectively connected to the top disc 2. The permanent or selective/reversible connection between the top disc 2 and the tube 17 is achieved via a thread connection, a detent, mechanical press fit, magnetic fit, or equivalent.

As illustrated in FIGS. 5B and 5C, before the cleaning step, the driving rod 4 can be axially moved to remove the driving rod 4 from the tube 17. In this embodiment, the driving rod 4 is coaxially disposed within the tube 17 and dimensioned for sliding engagement therebetween. Those skilled in the art will realize that the connection between the driving rod 4 and the tube 17 will utilize a detent, thread, magnetic, compression engagement, and the like and when the driving rod 4 is connected to the tube 17 it forms an indirect connection with the top disc 2. In addition, some embodiments include a driving rod 4 that is separate and not reversibly or permanently attached to the top disc 2 or lid assembly. The illustrated assembly includes a conventional lid. The lid 49 cooperates with the top of the carafe 1 to facilitate pouring coffee out of the carafe 1.

In such embodiments, the driving rod 4 may be selectively attached to the carafe 1, or the carafe supporting frame. More particularly, the driving rod 4 would be attached to the carafe 1 or carafe supporting frame during the coffee making step and then removed for the cleaning step.

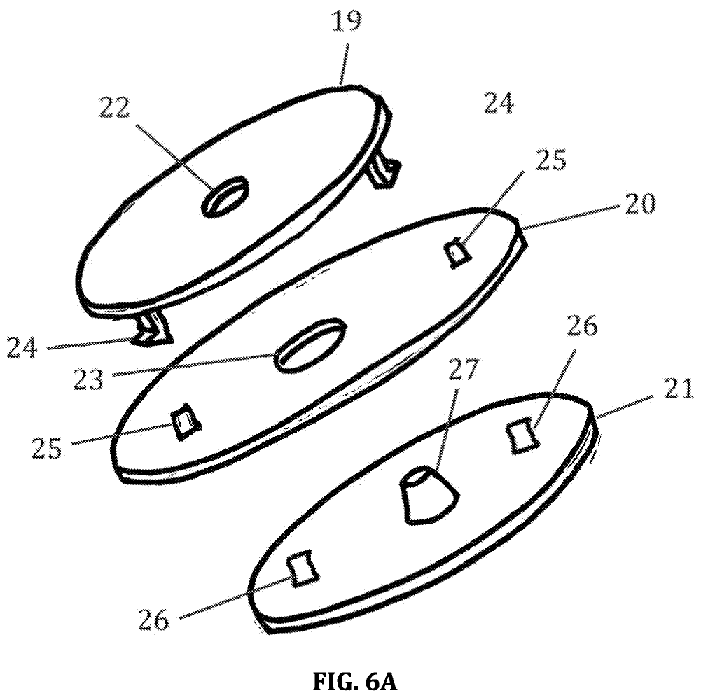

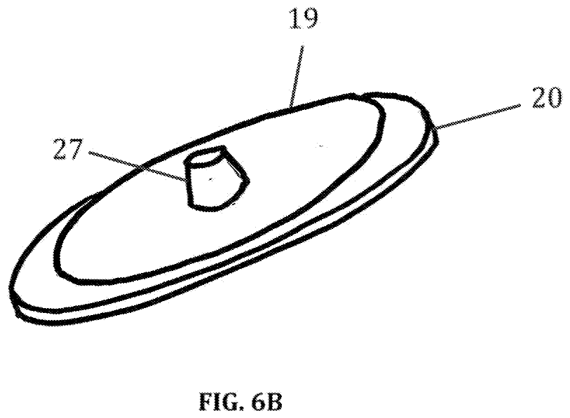

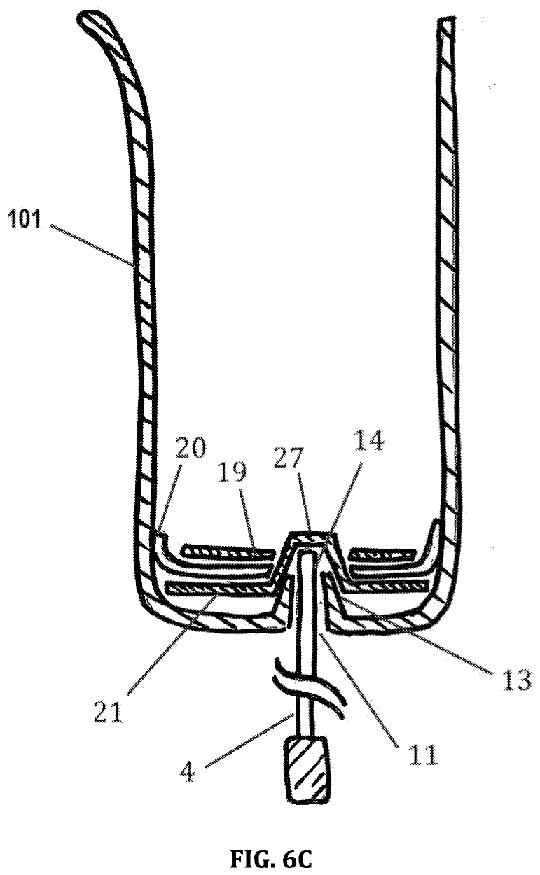

FIG. 6A illustrates a preferred embodiment for the bottom disc 3 comprising an assembly composed of an upper component 19, a middle component 20, and a lower component 21. The upper component 19 and lower component 21 are reversibly attached via a snap fit in which snap hooks 24 insert into snap hook openings 26. When assembled, the middle component 20 is sandwiched between the upper component 19 and lower component 21. The middle component 20 has holes 25 that allow the passage of the snap hooks 24. The bottom component 21 has a female luer taper 27 that mates with the male luer taper 13 of the carafe 1 as shown in FIG. 4B. The upper hole 22 and middle hole 23 allow the passage of the female taper 27 through the upper component 19 and middle component 20 respectfully and when assembled, as shown in FIG. 6B, the luer taper 27 protrudes above the top surface of the upper component 19. The middle component 20 has a larger outer diameter than the upper component 19 and the lower component 21. Therefore, when the components are assembled as shown in FIG. 6B, the outer edge of the middle component 20 protrudes radially beyond the outer edge of the upper component 19 and the lower component 21.

The upper component 19 and lower component 21 are, in some embodiments composed of a metal such as stainless steel, aluminum, or the like or a polymer such as acetal, HDPE, PET, PEEK, PTFE, or nylon. The middle component 20 would be composed of a flexible polymer or rubber such as silicone, nitrile, EPDM, neoprene or the like. The advantage of connecting the components via a reversible snap fit is that the assembly is easily disassembled and washed. Those of skill in the arts will appreciate that one or more snap fits of various geometries could be used to connect the assembly. Furthermore, the snap hooks could be located on the lower component. Moreover, a different reversible mating feature, such as one that uses threads, mechanical compression fit, one based on magnets, etc. could be used to connect the assembly. In another embodiment, one or more of the components could be constructed of disposable material. For example, the middle component could be constructed of a material similar to a paper-based coffee filter.

Those of skill in the art will appreciate the assembly in FIG. 6A can be manufactured via an insert, over-molded, or multiple shot injection molded process. In this fashion, sub-components having differing stiffness characteristics may be combined into one, permanent assembly.

FIG. 6C is a section view of a carafe 101, a bottom disc 3 assembly with upper component 19, middle component 20, and lower component 21 and driving rod 4. As shown, when the bottom disc 3 assembly is positioned at the bottom of the carafe 1, the female taper 27 is fully seated on the male luer taper 13 of the carafe 1 forming a water tight seal. The driving rod 4 has been inserted through the smaller bottom opening 11 passed through the male taper opening 14 and has bottomed out within the female luer taper 27 of the bottom disc 3 assembly. This is the configuration at the beginning of the cleaning step. As mentioned previously, the middle component 20 is made of a flexible material and has an outer diameter that is greater than the inner diameter of the carafe 1. This causes the outer edge of the middle component 20 to flex up and form a cup-like shape which aids in keeping the used coffee grounds from penetrating between the outer edge of the middle component 20 and the inner surface of the carafe 1. This design of the middle component 20 also allows for more forgiveness when dealing with manufacturing tolerance stack-ups and the mating fit between the bottom disc 3 assembly and the carafe 1. Those skilled in the art will recognize that the bottom disc assembly may be utilized in other carafe constructions.

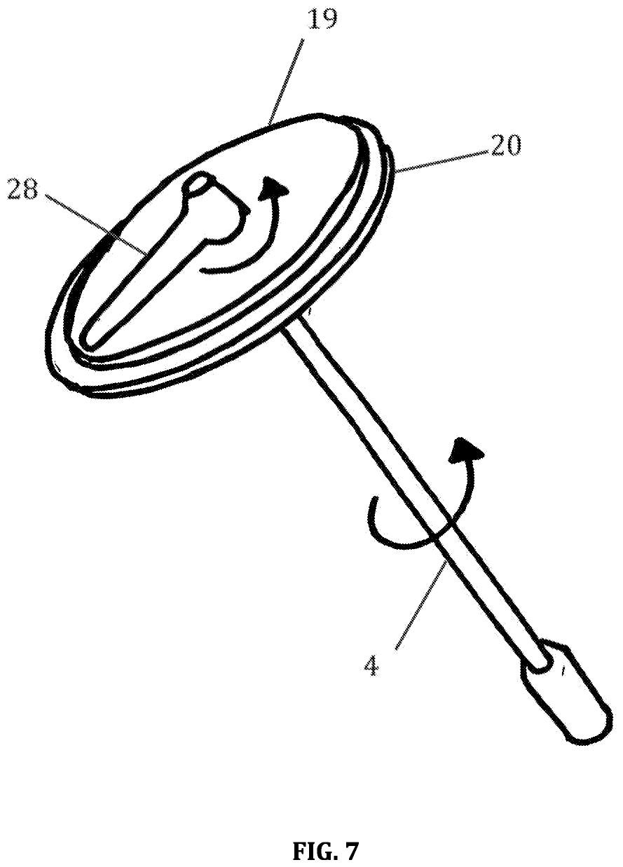

FIG. 7 illustrates the integration of a wiper element 28 into the bottom disc 3 assembly. For simplicity, the drawing omits, for example, carafe 1 shown in FIG. 1. The wiper element 28 snaps onto the top edge of the female luer 27 of the upper component from the bottom disc 3 assembly. Those of skill in the arts will appreciate that the fit between the wiper 28 and female luer could be permanent or reversible and could be achieved via many mating methods. In this embodiment, the female luer 27 has an opening at its top that would allow the driving rod 4 to be inserted into and reversibly attached to the bottom of the wiper element 28. The fit between the wiper element 28 and the female luer 27 is watertight to maintain the watertight fit between the bottom disc 3 assembly and the carafe 1. During the cleaning step, rotation of the driving rod 4 would cause the wiper element 28 to rotate and clean the used coffee grounds off the top surface of the upper component 19. The fit between the driving rod 4 and the wiper element 28 is keyed in some embodiments to ensure that rotation of the driving rod 4 causes rotation of the wiper element 28. Other interfaces to accomplish this coordinated rotation of the two components include a mechanical friction fit, a magnetic fit, a threaded fit, and the like. Alternate mechanisms to clean the used coffee grounds off the top surface of the upper component 19 include, but are not limited to, a first example includes a driving rod 4 which is really a tube that has an inner lumen and allows one to blow air or force liquid through the bottom end of tube so that air or liquid travels to the top surface of the upper component 19 and forces the used coffee grounds off the surface.

The cleaning action, in some embodiments, is facilitated by a construction, for example, as shown in FIG. 5B having a driving rod that provides a cooperating inner rod 4 and outer tube 17. During the cleaning step, the inner rod 4 is sequentially axially moved in and out of the tube 17. In some cases the driving rod 4 is sequentially moved in clockwise and counterclockwise directions about the axis thereof within the outer tube 17, and this will cause the upper component to move or vibrate causing the used coffee grounds to release from the top surface of the upper component 19.

Those of skill in the art will appreciate that the components described above and depicted in FIGS. 1-6C can be manufactured utilizing injection molding, machining, additive manufacturing, extrusions or a converting process, such as roll cutting or the use of a clicker press.

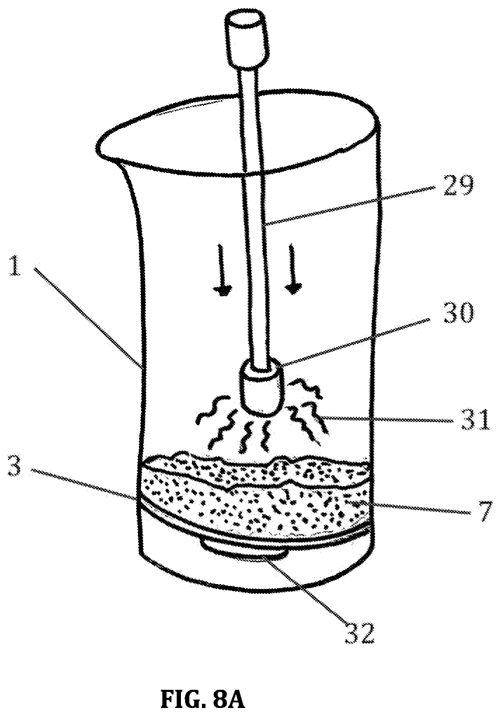

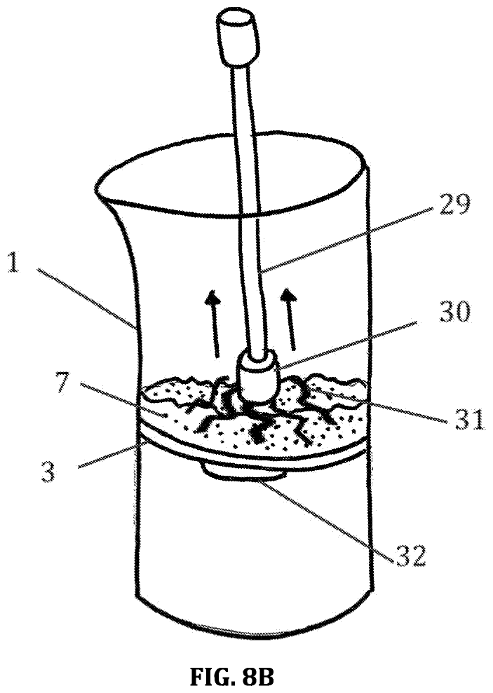

Another embodiment that would ease the process of cleaning a French press coffee maker is an assembly as shown in FIG. 8A. The drawing represents the beginning of a cleaning sequence. The assembly includes a magnet bottom disc 3 and a pulling rod 29. The pulling rod 29 is shown inserted into the top opening of the carafe 1. The pulling rod 29 has a pulling rod magnet 30 at its bottom tip. The bottom disc 3 is located at the bottom of the carafe 1. The used coffee grounds 7 are on the top surface of the bottom disc 3. As with the embodiment illustrated in 2A-2G, the bottom disc 3 forms a watertight seal with the carafe 1, though because there is no bottom opening in the carafe 1, this may not be necessary. The magnet bottom disc 32 is located underneath the bottom disc 3. Although the above description encompasses a permanent magnet 30 that produces a magnetic field 31 that attracts a bottom disc 3 manufactured of a ferromagnetic material, those skilled in the art will recognize other constructions relying on magnetic forces. For example, embodiments may use a permanent magnet or an electromagnet.

The magnet bottom disc 32 in various embodiments is permanently or selectively connected to the bottom disc 3. As the pulling rod magnet 30 approaches the magnet bottom disc 32 the magnetic force 31 of the pulling rod magnet 30 attracts the magnet bottom disc 32. In this embodiment, there is no opening at the bottom of the carafe 1. FIG. 8B illustrates the moment the magnetic force 31 of the pulling rod magnet 30 is close or strong enough to attract the magnet bottom disc 32 and move the bottom disc 3 upwardly within the carafe 1. The pulling rod 29 can then be withdrawn out the top opening of the carafe 1 and because the magnetic force 31 acts on the magnet bottom disc 32, the bottom disc 3 and used coffee grounds 7 are removed as the pulling rod 29 exits the top opening of the carafe 1. This step would be done over a trash can in similar fashion as shown in FIG. 2G.

The advantage of this embodiment is that a kit of the bottom disc 3, magnet bottom disc 32, and pulling rod 29 comprise an embodiment that would work with consumers' existing French Press.

Those skilled in the art will appreciate that the embodiment could be constructed such that the pulling rod tip 30 is simply a ferromagnetic metallic component or a magnetic component whereby the force between the attractive force between the tip 30 and the magnet bottom disc 32 is strong enough to attract the bottom disc 3 to the pulling rod tip 30 and begin the cleaning process. Conversely, the embodiment could be constructed such that the bottom disc 3 is metallic or incorporates metallic elements only but does not have a magnet and the magnetic force 31 from the pulling rod magnet 30 is strong enough to attract the bottom disc 3 to the pulling rod tip 30 and begin the cleaning process. Finally, the embodiment could utilize only the bottom disc 3 and magnet bottom disc 32 and the magnetic force 31 could be strong enough to attract the bottom disc 3 to the filter disc from the standard French Press lid assembly and the bottom disc 3 and used coffee grounds 7 could be removed when the standard French Press lid assembly is removed from the carafe 1. The advantage of these embodiments is that they are cost effective, simple for the consumer to use, and They are potentially the most universal. For example, (1) a kit could be created with a plurality of common disc sizes or (2) a set of kits having respective bottom disc 3 sizes to accommodate respective French press coffee makers that are sold on the market.

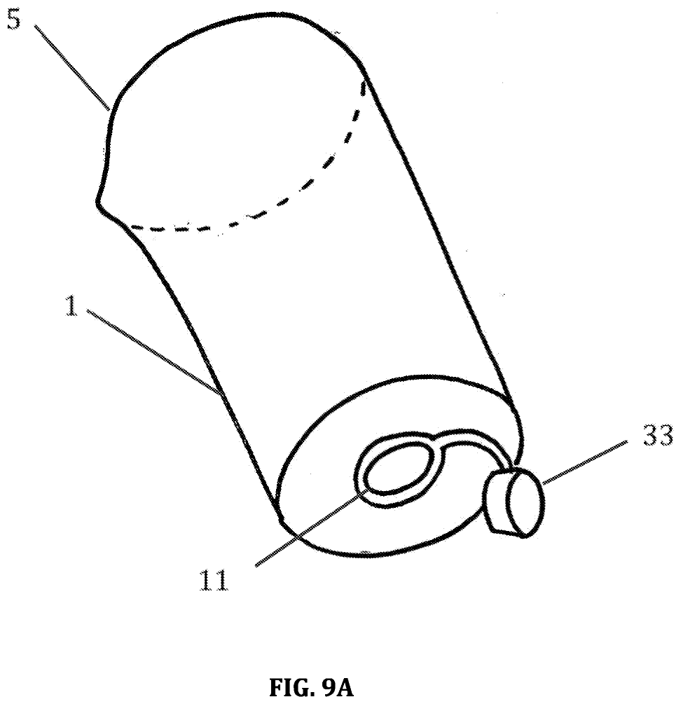

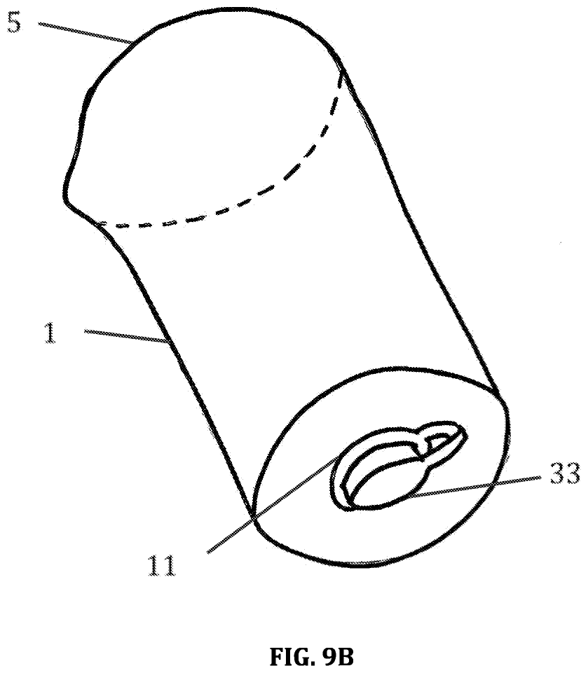

FIG. 9A illustrates an embodiment in which the smaller opening 11 in the bottomof the carafe 1 is selectively sealed with a bottom plug 33. The bottom plug 33 is attached by a lanyard to the bottom of the carafe 1. This attachment may be permanent or selective. The bottom plug in some embodiments is not attached to the carafe or any other component of the assembly.

Alternatively, the bottom plug is selectively attached to some other component of the assembly, such as the lid or the carafe frame. In FIG. 9A, the bottom plug 33 is shown not sealing the smaller bottom opening 11. This would be the configuration during the cleaning step in which case the driving rod 4 would pass through the bottom opening 11 and be used to push the bottom disc 3 and used coffee grounds out of the top opening 5 of the carafe 1 as described and shown in this disclosure previously. FIG. 9B illustrates the bottom plug 33 sealing the smaller bottom opening 11 of the carafe 1 via a friction fit. This would be the configuration during the coffee making step. The bottom plug 33 would form a watertight seal with the carafe 1 and ensure that no liquid would escape out of the smaller bottom opening 11 of the carafe 1. The advantage of this embodiment over the first embodiment is that a liquid tight seal would not have to be formed between the bottom disc 3 and the carafe 1. This may make the carafe 1 and the bottom disc 3 easier and cheaper to manufacture. The seal between the bottom disc 3 and the carafe 1 would only have to ensure that no used coffee grounds could pass between the bottom disc 3 and the carafe 1 during the cleaning step. The bottom plug 33 may be constructed of a flexible polymer or rubber such as silicone, nitrile, EPDM, neoprene or the like. The bottom plug could also be constructed of cork or some other organic or disposable material. The connection between the bottom plug 33 and the carafe 1 could be achieved with a mechanical friction or press fit, an adhesive bond, a threaded connection, a detent or the like. Those of skill in the art will appreciate that the bottom opening could be of various sizes and the plug could be scaled to fit. In addition, other methods besides a plug could be utilized to achieve a reversible sealing fit such as a slidable lid, a threaded cap or plug and a threaded bottom opening in the carafe, a disposable plug, etc . . .

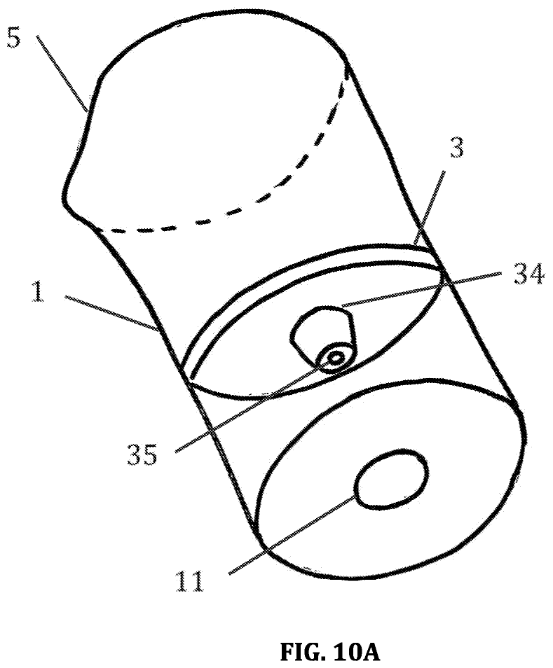

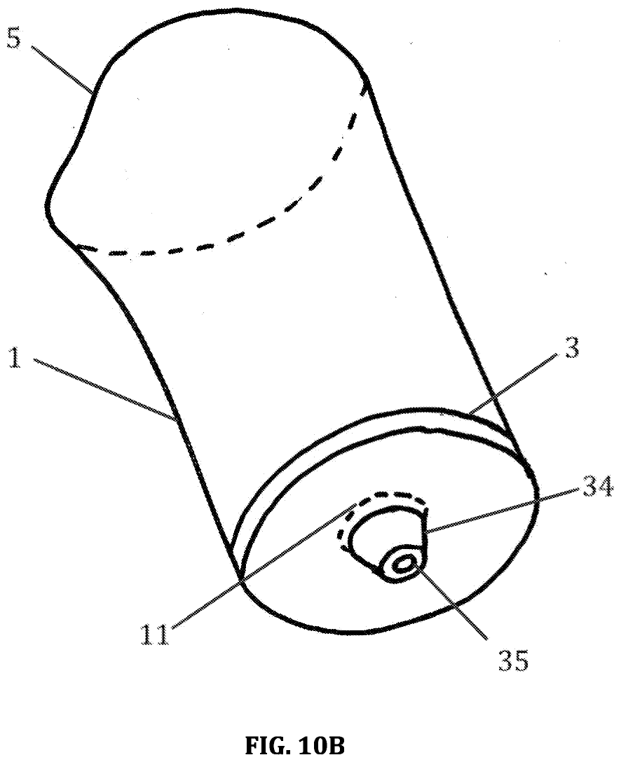

FIG. 10A illustrates another variation of the first embodiment depicted in FIG. 1 and FIGS. 2A-2G. In this variation, there is a smaller opening 11 at the bottom of the carafe 1 that is selectively sealed with a bottom disc bottom plug 34 located on the bottom surface of the bottom disc 3. The bottom disc bottom plug 34 would have a plug cavity 35 that would allow for the insertion of the driving rod 4 before the cleaning step. The bottom disc bottom plug 34 in some embodiments is constructed of a flexible polymer or rubber such as silicone, nitrile, EPDM, neoprene or the like as well as cork or a similar organic/sustainable material. The bottom disc bottom plug 34 is selectively or permanently attached to the bottom disc 3.

FIG. 10B illustrates the bottom disc bottom plug 34 sealing the bottom opening 11 of the carafe 1 via a friction fit. This arrangement of elements is desired during the coffee making step. The bottom disc bottom plug 34 forms a watertight seal with the carafe 1 and ensures that no liquid would escape out of the bottom opening 11 of the carafe 1. A potential advantage of this embodiment is that it would be simple and economical to manufacture and may also be the most simple to use.

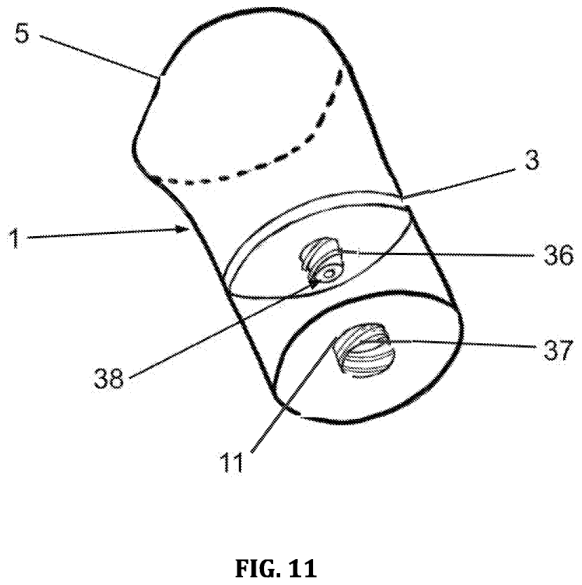

FIG. 11 illustrates a variation of the design shown in FIGS. 10A and 10B. In this embodiment, a bottom disc threaded bottom plug 36 is located on the bottom surface of the bottom disc 3. The bottom opening 11 of the carafe 1 has a threaded inner surface 37. When the bottom disc 3 is placed on the bottom of the carafe 1 before the coffee making step, the bottom disc 3 is rotated so that the threads of the bottom disc threaded bottom plug 36 engage the threads of the threaded inner surface 37. More particularly, the bottom disc 3 will be rotated until it is fully seated and the bottom opening 11 is occluded, forming a watertight seal between the bottom disc 3 and the carafe 1. The threaded plug cavity 38 provides a key feature whereby the driving rod 4 can be inserted into the threaded bottom plug 36 and rotated to disengage the bottom disc 3 from the carafe 1. The tip of the driving rod 4 will also provide a key feature. Once the bottom disc 3 has been rotated and released from the watertight seal, the bottom disc 3 can then be pushed to the top opening 5 of the carafe 1 with the driving rod 4 in a similar fashion as other designs described elsewhere in this disclosure.

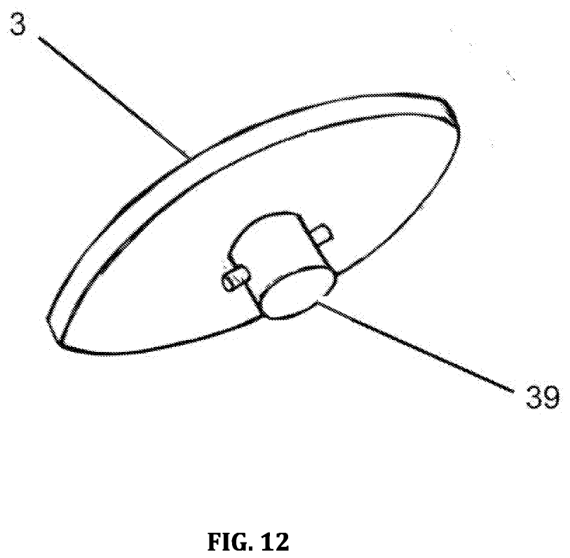

FIG. 12 illustrates a variation of the embodiment shown in FIG. 11. In this embodiment, the bottom disc 3 is provided with a bottom plug or boss with bayonet tabs 39. Though not shown, the boss or plug may, for example, include a coaxial central bore to accommodate a driving rod 4. The carafe 1 cooperating with the bottom opening 11 would have the corresponding geometry to receive the bayonet tabs 39. Those skilled in the art will appreciate that cooperative bayonet connection receiving features will be incorporated into the bottom surface of the carafe to form a watertight seal with the carafe 1.

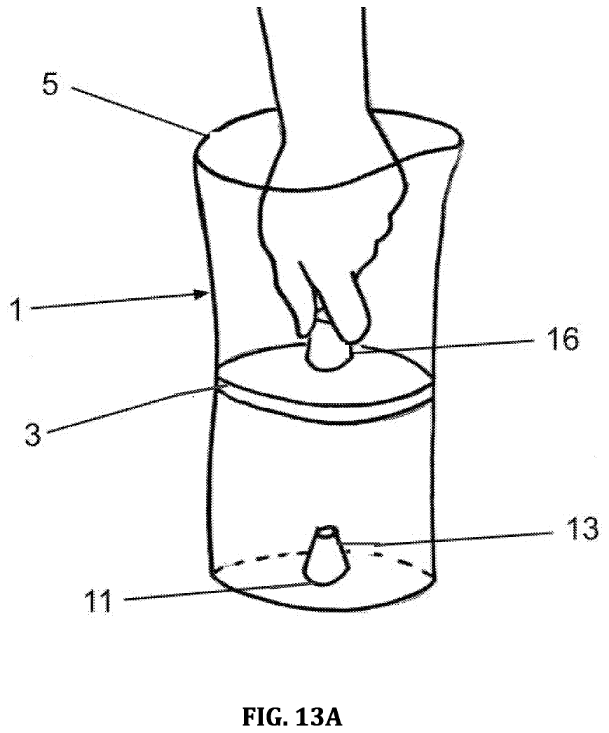

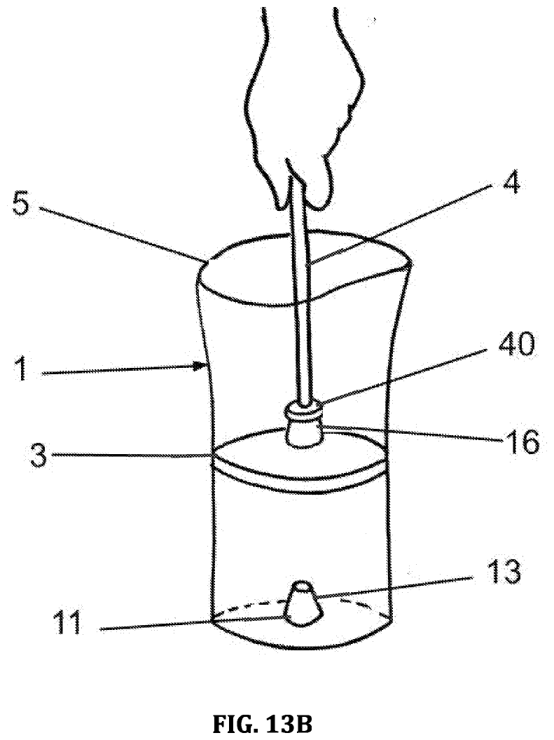

One of the utilization steps for the embodiments illustrated in FIGS. 1-7 and the embodiments illustrated in FIGS. 9-12 is the placement of the bottom disc 3 on the bottom of the carafe 1 before the coffee making step. FIG. 13A illustrates the placement of the bottom disc 3 by hand. With this method, the user can grab and use the top of the female luer 16 to hold onto and guide the bottom disc 3 through the top opening 5 and into position so that the female luer 16 is fully seated on the male luer 13 and the watertight seal is formed between the bottom disc 3 and the carafe 1. In addition to the top of the female luer, the bottom disc 3 could have other or additional features to allow the user to grab the disc such as a longer, rod-like feature, a handle, a finger or thumb ring, etc.

FIG. 13B illustrates the placement of the bottom disc 3 utilizing the driving rod 4. The driving rod 4 has a placement feature 40 that would allow for a reversible attachment to the top of the bottom disc 3. The placement feature 40 to bottom disc 3 reversible fit could be achieved via a thread, a detent, mechanical press fit, magnetic fit, bayonet fit, etc. The placement feature 40 could be the same feature and mechanism that reversibly attaches to the bottom of the bottom disc 3, or it could be different and be disposed on the side of the driving rod 4 opposite the end that connects to the bottom surface of the bottom disc 3. The advantage of this design and method is that the user doesn't have to reach as far into the carafe 1 to place the bottom disc 3 as he/she would have to with the hand placement method.

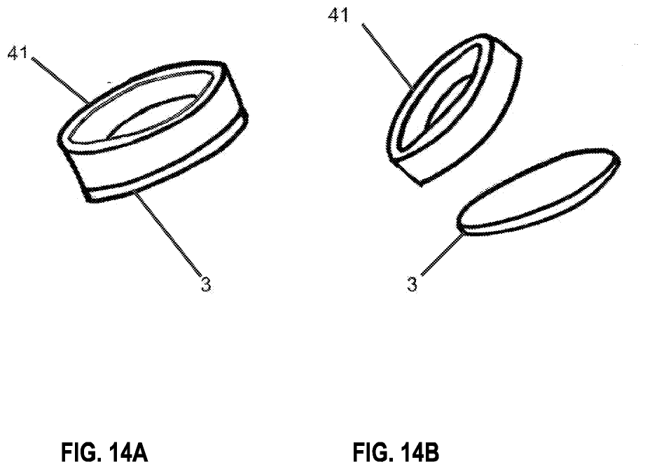

Those of skill in the arts will appreciate that the bottom disc 3 could have many different shapes and features for containing and facilitating the clean removal of the used coffee grounds from the carafe 1. For example, as illustrated in FIG. 14, the bottom disc 3 could have a a selectively removable sheet metal cylinder 41 having imperforate walls. This removable cylinder 41 contains the coffee grounds during the coffee making process. After completion of that process, the used coffee grounds are removed, typically the carafe 1 is placed over the trash can, the user removes the removable cylinder 41 and then wipes the coffee grounds off the bottom disc 3 and into the trash can. The removable cylinder 41 may be secured to the bottom disc 3 via a selective connection achieved via a snap fit, magnetic fit, friction fit, etc. In a variation, the can would be permanently connected to the bottom disc 3. In other embodiments, the bottom disc 3 will have other features such as an indent or lip that would give it more of a saucer, cup, or bowl shape. Those skilled in the art will recognize additional features and shapes of the bottom disc 3 will facilitate the containment as well as the disposal of coffee grounds.

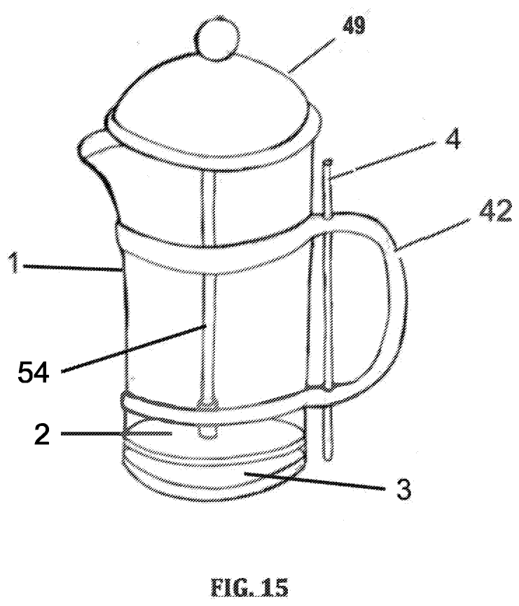

FIG. 15 illustrates an embodiment in which an additional driving rod 54 is added to the assembly. In this embodiment, the first driving rod 4 is separate and not reversibly or permanently attached to the top disc 2 or lid assembly. The additional driving rod 54 is reversibly or permanently attached to the top disc 2 or lid assembly. As shown in the drawing, the driving rod 4 is reversibly attached to the carafe supporting frame 42. Thus, the driving rod 4 is readily available for use. Those skilled in the arts will appreciate that the driving rod 4 could be attached to other parts of the carafe 1 or French press assembly or be completely separate.

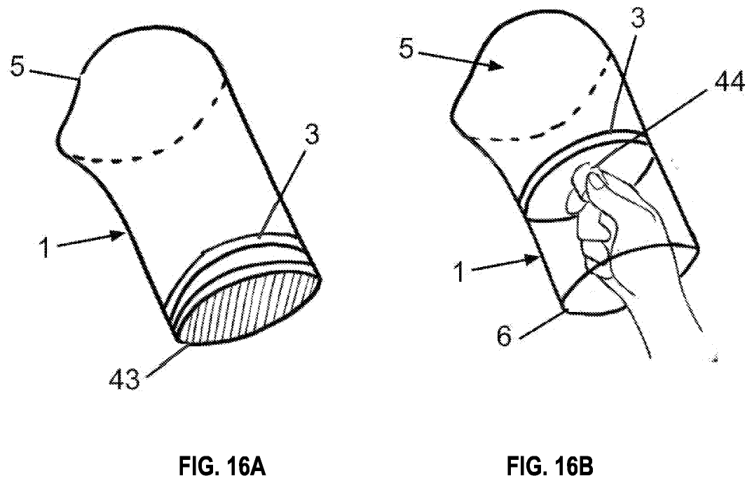

In the embodiments illustrated in FIGS. 1-7 and the embodiments illustrated in FIGS. 9-12, a driving rod 4 or 29 is used to push the bottom disc 3 out of the carafe 1 during the cleaning step. Other embodiments of the present invention dispense with the driving rod 4 or 29 to push the bottom disc 3 out of the carafe 1. For example, in the embodiment illustrated in FIGS. 16A and 16B, the assembly of top disc 3 cooperates with a carafe 1 with top opening 5 and bottom opening 6, stand 43, and a bottom disc 3. To simplify the drawing the top disc is not shown. FIG. 16A shows the assembly in the configuration during the coffee making step in which the stand 43 is selectively and reversibly attached to the bottom of the carafe 1 to form a watertight seal. This reversible attachment could be formed by a threaded fit, friction fit, magnetic fit, detents, snap fit, or the like. After the coffee making step, the bottom stand 43 is removed, and during the cleaning step, as shown on in FIG. 16B, the user pushes the bottom disc 3 towards the top opening 5 of the carafe 1 by hand through the bottom opening 6. In this embodiment, the bottom opening 6 would have to be large enough to accommodate the users' hands and arms. The bottom disc 3 could have a feature 44 that allows for the ease of grabbing and pushing the bottom disc 3. This feature could have ergonomic handle elements such as being constructed of a rubber material so that hands of various sizes could easily grasp and push the bottom disc 3. In another example, the feature could be a ring dimensioned and configured to engage the finger of a user.

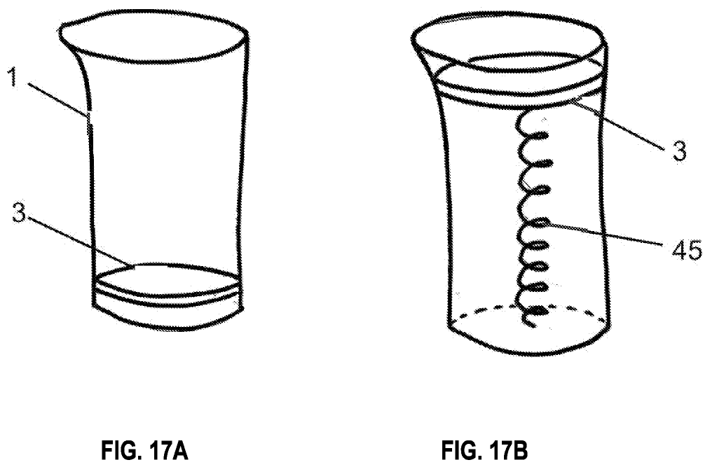

FIG. 17 illustrates another method in which the bottom disc 3 is removed without a driving rod 4. In this embodiment, there is a spring 45 on the bottom of the bottom disc 3 and during the coffee making step, the spring 45 would be compressed. During the cleaning step, the carafe 1 would be held over the trash can, and the spring 45 would be allowed to expand. The expansion of the spring causes the bottom disc 3 to move quickly to the top opening 5 of the carafe 1 and the used coffee grounds would be ejected into the trash can.

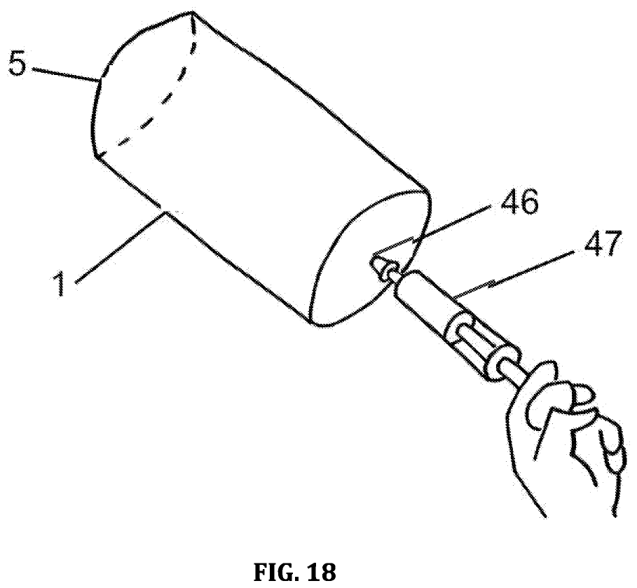

FIG. 18 illustrates an embodiment which doesn't utilize a bottom disc 3. In this embodiment, there is a simple bottom opening 46 that has a shape or geometry that accommodates a syringe. The opening would be capped or closed during the coffee making step and then during the cleaning step a syringe 47 or similar device would be utilized to push water, cleaning liquid, or air into the bottom of the carafe 1 and force the used coffee grounds out of the top opening 5 of the carafe.

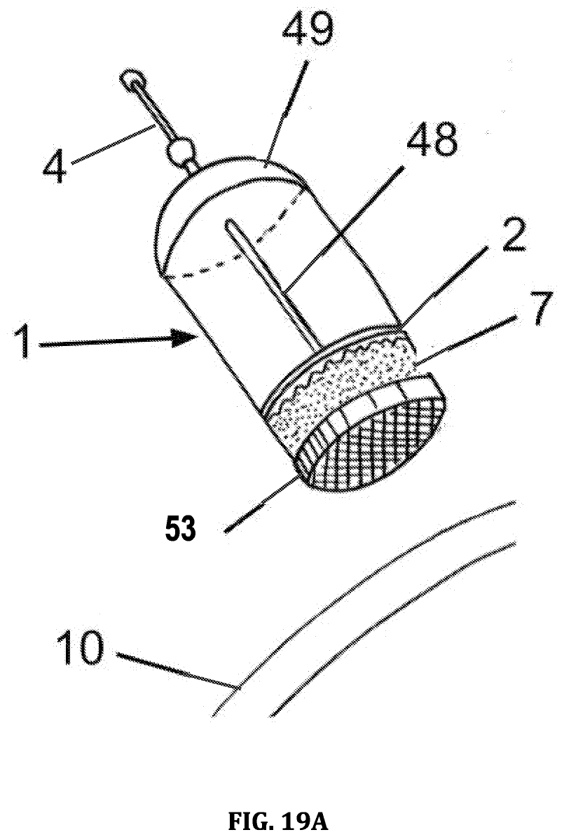

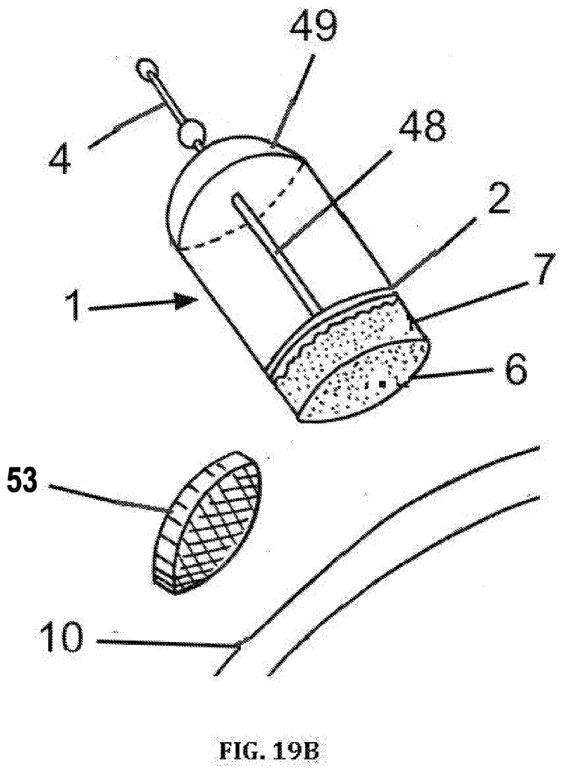

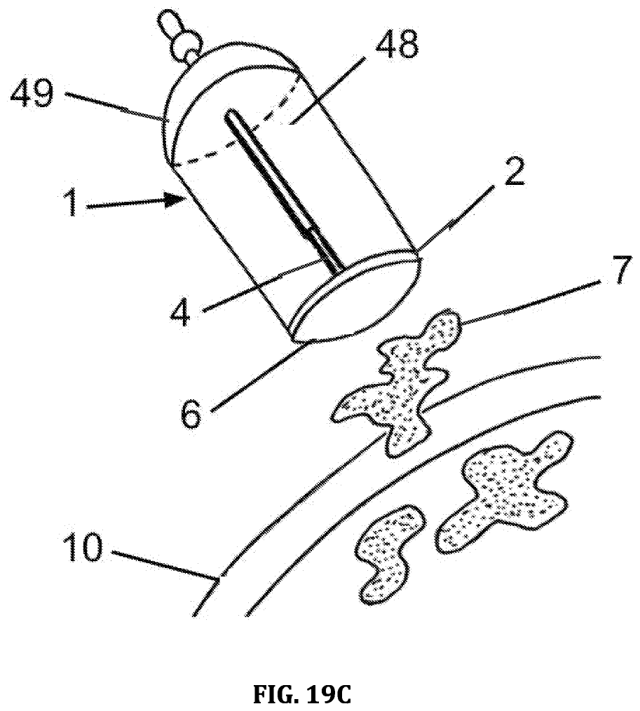

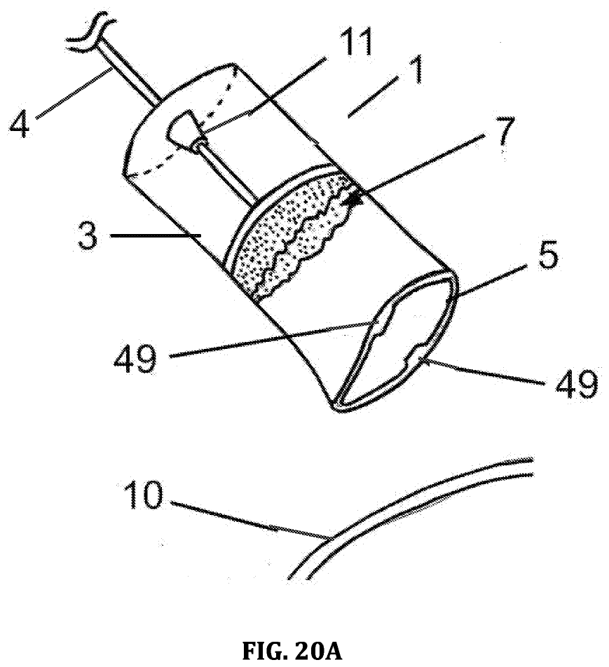

FIGS. 19A-19C illustrate an embodiment which doesn't utilize the bottom disc 3. FIG. 19A shows this embodiment at the beginning of the cleaning step when the carafe 1 is placed over the trash can 10. The driving rod 4 is permanently or reversibly attached to the top disc 2 and the driving rod can slide through a top tube 48 that is slidably attached to the French press top lid 49. A bottom lid 53 is reversibly attached and forms a watertight seal with the bottom of the carafe 1. This reversible attachment is secured by a threaded fit, friction fit, magnetic fit, detents, snap fit, or the like. During the beginning of this step, the used coffee grounds 7 are at the bottom of the carafe 1 and on the top surface of the bottom lid 53. The top disc 2 has been driven down so that it is bottomed out on top of the used coffee grounds 7.

As illustrated in FIG. 19B, the bottom lid 53 is removed and this opens up the bottom of the carafe 1 to expose the bottom opening 6 and used coffee grounds 7 for disposal in the trash can 10.

Finally, as illustrated in FIG. 19C, the driving rod 4 is axially pressed down and slides through and extends further out the top tube 48 bottom opening which causes the top disc 2 to move further in the direction of the bottom opening 6 and eject the used coffee grounds 7 into the trash can 10. Those skilled in the art will appreciate that the bottom lid could be replaced with other mechanisms or designs to reversibly open and close the bottom of the carafe 1. These mechanisms could include a sliding door, an iris, a disposable lid, etc . . . Those of skill in the art will appreciate that the separate driving rod 4 may not be necessary for this embodiment. In this case, the rod that connects the top disc to the French Press lid assembly may be longer than the height of the carafe 1. When the coffee is brewed, the rod will always bottom out on the used coffee grounds and this will leave a length of the rod above the French Press lid. Then, when the bottom lid is removed, the rod can be pushed further down so that the top disc exits the bottom opening 6 and the used coffee grounds 7 would be ejected into the trash can 10.

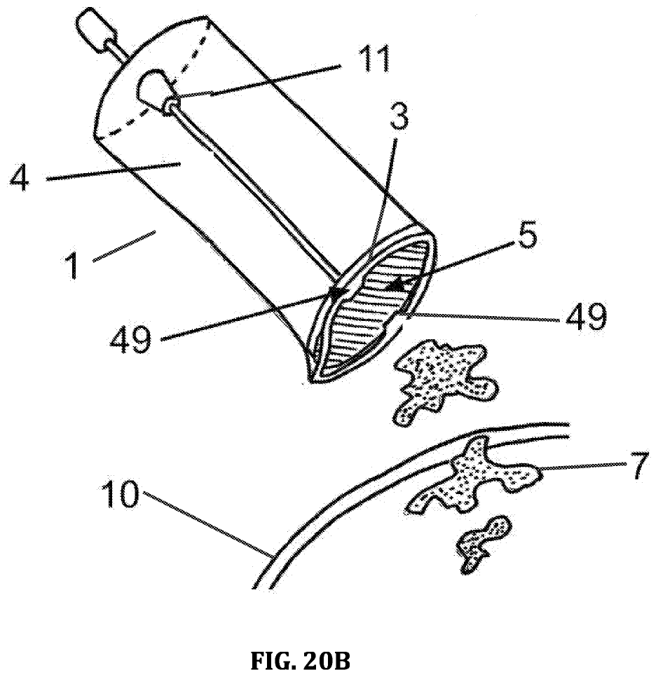

FIGS. 20A-20B illustrate an embodiment that has a feature for improving the ejection of the used coffee grounds 7 into the trash can 10. FIG. 20A shows the beginning of the cleaning step when the carafe 1 is placed over the trash can 10. At the top opening 5 of the carafe 1, there are tabs 49 that protrude slightly into the inner diameter of the carafe 1. As illustrated in FIG. 20B, when the bottom disc 3 reaches the top opening 5 of the carafe 1, the tabs impede the further advancement of the bottom disc 3. Meanwhile, the used coffee grounds 7 are not impeded and the momentum of the advancement of the bottom disc 3 is transferred to the used coffee grounds 7 which are more easily separated from the bottom disc 3 and then ejected out and into the trash can 10.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “an imager” should typically be interpreted to mean “at least one imager”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two images,” or “a plurality of images,” without other modifiers, typically means at least two images). Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the invention has been described in terms of various specific embodiments, those skilled in the art will recognize that the invention can be practiced with modification within the spirit and scope of the claims. While certain embodiments of the invention have been illustrated and described, various modifications are contemplated and can be made without departing from the spirit and scope of the invention. Accordingly, it is intended that the invention is not to be limited, except as by the appended claim(s).

The teachings disclosed herein may be applied to other systems and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the present invention with which that terminology is associated. In general, the terms used in the following claims should not be constructed to limit the present invention to the specific embodiments disclosed in the specification unless the above description section explicitly define such terms. Accordingly, the actual scope encompasses not only the disclosed embodiments, but also all equivalent ways of practicing or implementing the disclosed present invention. The above description of embodiments of the present invention is not intended to be exhaustive or limited to the precise form disclosed above or to a particular field of usage.

While certain aspects of the present invention are presented below in particular claim forms, various aspects of the present invention are contemplated in any number of claim forms. Thus, the inventor reserves the right to add additional claims after filing the application to pursue such additional claim forms for other aspects of the present invention.

1. A French press apparatus comprising:
a carafe having an open top and an open bottom, said top and said bottom being coaxial, said carafe being axially elongated and having the same internal cross-section at a plurality of axially spaced intervals;
a top disc having a peripheral edge that is dimensioned and configured for sealing engagement with respective internal cross-sections of said carafe, said top disc being perforate and allowing liquid passage through at least a part of the surface thereof;
a bottom disc having a peripheral edge that is dimensioned and configured for sealing engagement with respective internal cross sections of said carafe, said bottom disc being imperforate and all of or a portion forming a reversible, waterproof mate with the carafe;
an elongated driving rod disposed in a perpendicular relationship to said top disc, an axial part of said elongated driving rod being selectively engaged with said top disc whereby an axial force on said elongated driving rod will plunge said top disc through any liquid disposed above said bottom disc, and
an axial part of said elongated driving rod also being disposed in perpendicular relationship to said bottom disc and selectively engaged with said bottom disc to facilitate removal of said bottom disc and cleaning of said apparatus.

2. The apparatus as described in claim 1 wherein the selective engagement between said driving rod and either disc is achieved by structure selected from the group consisting of helical threads, a snap fit, a compression fit, and a detent mechanism.

3. The apparatus as described in claim 1 where the bottom opening is smaller than the top opening.

4. The apparatus as described in claim 3 further including a valve disposed in said bottom opening.

5. The apparatus as described in claim 4 wherein said valve is a a passive valve.

6. The apparatus as described in claim 5 wherein said valve opens and closes responsive to rotation of a sleeve.

7. The apparatus as described in claim 4 wherein said valve is an active valve.

8. The apparatus as described in claim 7 wherein said valve is a Tuohy-Borst valve.

9. The apparatus in claim 3 further including cooperating first and second luer tapers respectively installed in said bottom disc and bottom of carafe.

10. The apparatus as described in claim 1 wherein said bottom disc is manufactured of a material having a low friction surface.

11. The apparatus as described in claim 10 wherein said bottom disc is manufactured of a material selected from the group consisting of acetal, nylon, PET, PEEK, UHMW, HDPE, and PTFE polymers, and PTFE coated metal.

12. The apparatus as described in claim 1 wherein said bottom disc is disposable.

13. The apparatus as described in claim 12 wherein said bottom disc is both disposable and compostable.

14. A French press apparatus comprising:
a carafe having an open top and an open bottom, said carafe being axially elongated and having the same internal cross-section at axially spaced intervals;
a top lid dimensioned and configured to engage the open top of said carafe;
a top disc having a peripheral edge that is dimensioned and configured for sealing engagement with respective internal cross-sections of said carafe, said top disc being perforate and allowing liquid passage through at least a part of the surface thereof;
a tube permanently or selectively connected to said top disc and extending through said top lid;
said tube being disposed in substantially perpendicular relationship to said top disc;
a bottom disc having a peripheral edge that is dimensioned and configured for sealing engagement with respective internal cross sections of said carafe, said bottom disc being imperforate and all of or a portion forming a reversible, waterproof mate with the carafe;
an elongated driving rod disposed in telescopic relationship to said top disc and tube, an axial part of said elongated driving rod being selectively engaged with said top disc and tube whereby an axial force on said elongated driving rod will plunge said top disc and tube through any liquid disposed above said bottom disc, and
an axial part of said elongated driving rod also being disposed in perpendicular relationship to said bottom disc and selectively engaged with said bottom disc to facilitate removal of said bottom disc and cleaning of said apparatus:

15. The apparatus as described in claim 14 wherein the connection between said top disc and said tube is achieved with structure selected from the group consisting of a detent, mechanical press fit, and magnetic fit.

16. The apparatus as described in claim 14 further including a handle on said carafe and said handle includes aligned holes dimensioned and configured for receiving a driving rod for access.

17. The apparatus as described in claim 9 wherein said carafe is cylindrical and said bottom disc is an assembly of
(a) an upper disc shaped component having a center hole and depending hook members;
(b) a flexible middle component having a diameter that is larger than said upper disc and larger than the diameter of the internal cross-section of said carafe whereby the edges of said flexible middle component will flex up and form a cup like shape to aid in keeping the used coffee grounds from penetrating between the outer edge of the middle component and the inner surface of said carafe, said flexible middle component having holes therein aligned with said depending hook members to allow passage through said flexible middle component; and
(c) a bottom component having a diameter smaller than said flexible middle component and having holes that are registered with respect to said depending hook members whereby when assembled the middle component protrudes radially beyond said upper component and said bottom component.

18. The apparatus as described in claim 17 wherein said driving rod extends through said luer and said driving rod is reversibly attached to a radially extending wiper disposed for wiping a face of said bottom disc responsive to rotational movement of said driving rod.

19. A method for manufacturing French press apparatus comprising:
providing a carafe having an open top and an open bottom, said top and said bottom being coaxial, said carafe being axially elongated and having the same internal cross-section at a plurality of axially spaced intervals;
providing a top disc having a peripheral edge that is dimensioned and configured for sealing engagement with respective internal cross-sections of said carafe, said top disc being perforate and allowing liquid passage through at least a part of the surface thereof;
providing a bottom disc having a peripheral edge that is dimensioned and configured for sealing engagement with respective internal cross sections of said carafe, said bottom disc being imperforate and all of or a portion forming a reversible, waterproof mate with the carafe.
providing an elongated driving rod disposed in a perpendicular relationship to said top disc, with an axial part of said elongated driving rod being selectively engaged with said top disc whereby an axial force on said elongated driving rod will plunge said top disc through any liquid disposed above said bottom disc, and
providing an axial part of said elongated driving rod disposed in perpendicular relationship to said bottom disc and selectively engaged with said bottom disc to facilitate removal of said bottom disc and cleaning of said apparatus.

20. A method for manufacturing French press apparatus comprising:
providing a carafe having an open top and a bottom that is closed except for single opening, said top and said bottom being coaxial, said carafe being axially elongated and having the same internal cross-section at a plurality of axially spaced intervals;
providing a top disc having a peripheral edge that is dimensioned and configured for sealing engagement with respective internal cross-sections of said carafe, said top disc being perforate and allowing liquid passage through at least a part of the surface thereof;
providing a bottom disc having a peripheral edge that is dimensioned and configured for sealing engagement with respective internal cross sections of said carafe, said bottom disc being imperforate providing a male luer taper in said single opening in the bottom of the carafe;
providing a female luer taper in the in the bottom disc, the female luer taper being disposed in registered cooperating relationship with the male luer taper and forming a liquid tight seal when fully mated to the male taper providing a driving rod dimensioned to be inserted in the male luer to pass through the bottom of the carafe and abut the interior of the female luer whereby the bottom disc is axially displaced within the carafe.

21. A method of producing and utilizing a French press apparatus which comprises:
providing a carafe having an open top and an open bottom disposed in coaxial relation and, being axially elongated and having the same internal cross-section at axially spaced intervals thereof;
providing a bottom disc dimensioned for sealing engagement with the internal construction that is imperforate and all of or a portion forming a reversible waterproof mate with the carafe and has a peripheral edge dimensioned and configured for sealing engagement with respective internal cross sections of said carafe;
positioning said bottom disc within the carafe to allow depositing coffee grounds and hot water on the bottom the disc;
providing a top disc dimensioned for sealing engagement with the internal construction that is perforate and allows liquid passage through at least a part of the surface thereof and having a peripheral edge is dimensioned and configured for sealing engagement with respective internal cross sections of said carafe;
axially moving said top disc downward to the force liquid to penetrate said top disc;
discharging coffee from the carafe;
removing said top disc from the carafe;
connecting a driving rod to the bottom disc; and
withdrawing said bottom disc from the carafe to facilitate cleaning.
providing a ferromagnetic mass under the bottom disc;
placing a magnet proximate to the feromagnetic mass to withdraw the bottom disc from the open top of the carafe.

22-30. (canceled)
